(19) United States
(12) Patent Application Publication
(10) Pub. No.: US 2023/0249138 A1
(43) Pub. Date: Aug. 10, 2023

(54) PROCESS OF MANUFACTURE OF NON-OXIDE CERAMIC FILTRATION MEMBRANE

(71) Applicant: MANN+HUMMEL LIFE SCIENCES & ENVIRONMENT HOLDING SINGAPORE PTE. LTD., Singapore (SG)

(72) Inventors: Frank EHLEN, Neunkirchen (DE); Sabine GIESSELMANN, Ludwigsburg (DE)

(21) Appl. No.: 18/300,473

(22) Filed: Apr. 14, 2023

Related U.S. Application Data
(63) Continuation of application No. PCT/IB2021/059951, filed on Oct. 28, 2021.

(30) Foreign Application Priority Data
Oct. 28, 2020 (EP) 20204369.1

(51) Int. Cl. B01D 71/02; B01D 67/00; B01D 69/10

(52) U.S. Cl. CPC B01D 71/024; B01D 67/00411; B01D 67/0076; B01D 69/108; B01D 2323/081

(57) ABSTRACT

The present disclosure relates to a method of preparing oxide and non-oxide ceramic filtration elements with a high abrasion resistance, wherein the process of manufacture allows low sinter temperatures in the presence of atmospheric oxygen, wherein the obtained non-oxide filter membrane shows typical behavior of non-oxide ceramic filtration elements.

### CROSS-REFERENCE TO RELATED APPLICATIONS

This application is a continuation application of International Application No. PCT/162021/059951 filed on Oct. 28, 2021, which claims the benefit of European Application No. 20204369.1 filed on Oct. 28, 2020, the entire disclosures of which are incorporated herein by reference for all purposes.

### BACKGROUND

The present invention relates to a process for the manufacture of a ceramic filter membrane for nanofiltration purposes in liquid purification processes, and the ceramic filtration element.

The provision of clean and drinkable water is one of the emerging problems to be solved in view of the worldwide growth of population and industrialization along with natural disasters. Water may be polluted with bacteria, viruses, protozoa and fungi, bacteriological and biological concomitants, biologically active or toxic substances with high molecular weight, or micro plastics which may threaten the health of humans. In addition to that, industrial wastewaters may be polluted with organic chemicals, dissolved solids or suspended material.

To reduce the amount of released pollutants, the amount of toxic wastes, or the volume of reaction mixtures to be purified in an energy efficient manner, filter membranes are often used for filtration or separation purposes, e.g. in the purification of industrial wastewater or process fluids. These filter membranes may be polymeric membranes or ceramic membranes. The latter ones are often preferred over polymeric membranes, especially in filtration or separation processes involving aggressive media such as strongly acidic or strongly basic wastewaters.

In the prior art, two classes of ceramic filtration membranes are known: oxidic and non-oxidic filtration membranes.

Oxidic ceramic filtration membranes consist of particles of metal oxides, aluminum oxide (Al₂O₃), beryllium oxide (BeO), calcium oxide (CaO), hafnium oxide (HfO₂), iron oxide (FeO/Fe₂O₃), lanthanum oxide (La₂O₃), magnesium oxide (MgO), manganese oxide (MnO₂), silicon dioxide (SiO₂), strontium oxide (SrO), thorium oxide (ThO₂), titanium dioxide (TiO₂), yttrium oxide (Y₂O₃), zirconium dioxide (ZrO₂) or mixtures thereof. The process of manufacture of oxidic ceramic filter membranes is usually achieved by a sol-gel process, in which a support surface is coated with a sol containing a precursor metal compound, e.g. a metal alcoholate. In the course of drying and sintering, the precursor is oxidized to the corresponding metal oxide forming membrane layers with small pore sizes.

Non-oxide ceramic filter membranes, on the other hand side, consist of particles silicon carbide (SiC), silicon nitride (Si₃N₄), tungsten carbide (WC), aluminum nitride (AlN) or boron nitride (BN), for example. Membranes prepared from non-oxide ceramic nanoparticles usually have excellent properties with regard to their resistance to corrosive media and low tendency of membrane fouling due to the low isoelectric point. For the preparation of non-oxide ceramic filter membranes, sol-gel processes are not applicable. Therefore, non-oxide ceramic filter membranes are usually prepared by sintering of powders with a narrow size distribution. Thereby, the pore size and the volume of the pores can be adjusted through a careful selection of the particles. The strong covalent bonding in non-oxide ceramic nanoparticles, e.g. between silicon and carbon, however, renders the sintering process more difficult than the processes used in the manufacture of oxide ceramic filter membranes because the diffusion is limited. To overcome this, and to prevent the formation of metal oxides during the sintering process, the conditions have to be carefully chosen: The sintering can only be successful at very high temperatures (e.g., about 2,500° C.) close to the decomposition temperature of the material used and under exclusion of oxygen, i.e. through application of a vacuum or sintering under inert atmosphere. Hence, non-oxide ceramic filter membranes are difficult to prepare and expensive.

Alternatively, the temperature required in the sintering process can be reduced by the use of additives which, on the down hand side, may render the exact adjustment of the pore size difficult, change the properties of the ceramic filtration membrane and reduce the quality. Common sintering aids are modifications and derivatives of silicon dioxide (SiO₂), e.g. glass, borosilicate glass, cristobalite or mullite. During the process of sintering, these additives form bridges between the non-oxide nanoparticles to establish a solid network. Nevertheless, it has to be noted that this silicone dioxide based components of the ceramic filter membrane limit the mechanical strength and the resistance towards corrosive media. The excellent properties the non-oxide ceramic materials can hence not be utilized to the full potential.

Therefore, the provision of ceramic filter membranes which utilize the advantageous properties of ceramic materials to the full potential, particularly non-oxide ceramic materials, but which membranes—at the same time—can be prepared at low sintering temperatures omitting the necessity of inert atmosphere while sintering is highly desirable.

### SUMMARY

The present disclosure relates to ceramic filtration elements comprising a support structure and a filtration layer, wherein the filtration layer comprises at least first particles and second particles, wherein the second particles are selected from the group consisting of oxide ceramic particles, and wherein the first and second particles differ in at least their D₅₀ diameter, characterized in that the ratio (Z) of the particle size of the first particles Q₁ (D₅₀) and the particle size of the second particles Q₂ (D₅₀) is in the range of 2 to 5,000.

In a second aspect, the present disclosure relates to a process for manufacture of said ceramic filtration elements, wherein the process of manufacture comprises the steps of providing a support structure having a support surface, and a coating suspension comprising the first and second particles, contacting the support surface with the coating suspension for a duration of time, preferably for 10 to 120 seconds, more preferably for 60 seconds or for 30 seconds, removing excess coating suspension without removing a residual film of coating suspension, drying the residual film, preferably for 2 to 6 h at a temperature in the range of from 60° C. to 90° C., and sintering the support structure with the residual film, optionally repeating steps b) to e), preferably up to 7 times, more preferably up to 5 times.

### BRIEF DESCRIPTION OF THE DRAWINGS

FIG. 1 is a picture of cross section of filtration layer comprising first and second particles obtained by REM after sintering.

FIG. 2 shows, in portion A, a picture of the surface of a filtration layer according to the present disclosure, and in portion B, an elemental analysis by Energy Dispersive X-Ray Analysis of the membrane

FIG. 3 is a zeta potential of two membranes according to Example 1 comprising 30 wt.-% of ZrO₂ as second particles.

### DETAILED DESCRIPTION

The present disclosure relates, in a first aspect, to ceramic filtration elements comprising a support structure and a filtration layer, wherein the filtration layer comprises at least first particles and second particles, wherein the second particles are selected from the group consisting of oxide ceramic particles, and wherein the first and second particles differ in at least their D₅₀ diameter, characterized in that the ratio (Y) of the particle size of the first particles Q₁ (D₅₀) and the particle size of the second particles Q₂ (D₅₀) is in the range of 2 to 5,000.

An object of the present invention is to provide a ceramic filtration element formed on a porous support material and having satisfactory flow, high permeability of low molecular weight compounds and high retention of high molecular weight compounds, including particles of certain size. The filtration element should be easily prepared from suspensions of particles of ceramic compounds at low cost, e.g. without the requirement of high temperatures and without the requirement of inert atmosphere during sintering. Furthermore, an object of the present invention is the provision of filtration elements which exhibit a high stability against thermic, chemical and mechanical stress resulting in a superior abrasion stability and advantageous cleaning properties. Additionally, the skilled person should be able to design the chemical properties of the filtration element, such as the zeta-potential of the membrane surface or the hydrophilic or hydrophobic properties, easily to obtain an optimal filtration element for each purpose of use. By use of metal carbides comprised in the filtration layer, highly hydrophilic properties and low contact angles can be achieved, i.e., the filtration element has a low resistance to the transport of water. Furthermore, filtration elements according to the present disclosure may exhibit a lower tendency of fouling, may be easier to clean and have very high fluxes. For example, a filtration element having an isoelectric point of up to 3 may be prepared from SiC and 30 wt.-% of ZrO₂ particles which exhibits unmatched performance in the separation of oil from water.

The inventors of the present disclosure found, surprisingly, that oxide and non-oxide ceramic filtration layers can be prepared in a less energy consuming and less expensive way by the addition of small oxide ceramic particles to aid the sintering process during the process of manufacture of the disclosed filtration elements. This is highly desirable because the addition of small metal oxide ceramic particles may not only improve the strength of the membrane coating, but may at the same time reduce the temperature required for the sintering of ceramic particles, and may also eliminate the requirement of inert atmosphere for sintering steps, while the product characteristics of pore size, chemical behavior (e.g. the zeta-potential and inertness), porosity, and filtration performance are maintained. This results in a significant saving in manufacture time and energy consumption.

### Definitions

In the sense of the present disclosure, a ceramic filtration element comprises a support structure and a filtration layer. The support structure is a porous material allowing liquids and gases to pass through the support structure. Furthermore, it determines the shape of the filtration element and supports the filtration layer to provide it with mechanical strength and prevent breaking of the filtration element. The filtration layer is directly adjacent to the support structure and constitutes a porous layer with defined pore size which allows liquids and gases to penetrate through the filtration layer. Depending on the size of pores, compounds of a certain molecular weight and/or aggregates of a certain size cannot penetrate through the filtration layer. In a filtration process, said compounds or aggregates comprised in a feed liquid or gas, also regarded to as “feed”, cannot pass through the filtration layer, i.e., remain in the feed. The concentration of said compounds and/or particles is thus increased in the feed, whereas the liquid passing through the filtration layer, also regarded to as the “filtrate”, does not contain said compounds and/or aggregates, or has a reduced concentration of said compounds and/or aggregates compared to the feed. In other words, the pores of the filtration elements according to the present disclosure are free and conductive for liquids and gases, in particular the filtration elements according to the present application are conductive to liquids.

In the sense of the present disclosure, the filtration layer comprises at least two different types of particles:

particles of at least one ceramic compound determining the mean pore size, the porosity, the chemical properties, such as the zeta-potential, hydrophilic or hydrophobic properties, and the stability against corrosive media, such as acids and bases. In the sense of the present disclosure, the particles of a ceramic compound may be selected from the group consisting of particles of at least one metal oxide, particles of at least one metal carbide and particles of at least one metal nitride. Said particles of a ceramic compound may be regarded as “first particles” for the present disclosure.

particles of at least one metal oxide serving as a bonding component to provide a strong bonding between the first particles without the requirement of high sinter temperatures and/or inert atmospheres during sintering, and to provide a high mechanical strength and abrasion stability and high chemical stability (without relevant reduction the chemical stability of the layer). Hence, only particles which exhibit a high resistance against aggressive chemicals, such as acids and bases, a high sinter activity at low temperatures, in particular at below 500° C., and a good bonding to the first particles are suitable materials. In the sense of the present disclosure, the size of this sort of particles is smaller than the size of the first particles. For the present disclosure, this sort of particles is referred to as “second particles”.

In the sense of the present disclosure, the size of a of first and second particles is characterized by their mean diameters Q₀, i.e. their numerical D₁₀, D₅₀ and D₉₀ values determined by dynamic light scattering (DLS) if not specified otherwise. D₁₀ is defined as the diameter of the particles, wherein the portion of particles with diameters smaller than or equal to this value is 10% with respect to the total number of particles. Thus, 10% of the particles in the batch have a diameter smaller than or equal to the value of D₁₀, and 90% of the particles have a diameter larger than the value of D₁₀. This is thus a number distribution of the particles. In a similar manner, D₅₀ is defined as the diameter of the particles, wherein the portion of particles with diameters smaller than or equal to this value is 50% with respect to the total number of particles. Finally, D₉₀ is defined as the diameter of the particles, wherein the portion of particles with diameters smaller than or equal to this value is 90% with respect to the total number of particles. In the sense of the present disclosure, all particle diameters are determined by DLS. This can in particular be determined with a Nanotrac Flex nanoparticle size analyzer (obtained from Microtrac MRB).

The particles of the present disclosure can be characterized by their particle size distribution expressed by:

$$Z = \frac{{D}_{90} ( of particles )}{{D}_{10} ( of particles )} .$$

In other words, the Z-ratio, i.e., Z, is the quotient of the particle size D₉₀ of the particles composing the filtration layer and the particle size D₁₀ of the same particles composing the filtration layer.

The proportions between the first and second particles can be characterized by their ratio of mean particle diameters expressed by:

$$Y = \frac{{D}_{50} ( of first particles )}{{D}_{50} ( of second particles )} .$$

In other words, the Y-ratio, i.e., Y, is the quotient of the mean particle size D₅₀ of the first particles composing the filtration layer and the mean particle size D₅₀ of the second particles composing the filtration layer.

In the sense of the present disclosure, particles of a ceramic compound may be selected from the group consisting of particles of at least one metal oxide, particles of at least one metal carbide and particles of at least one metal nitride.

In the sense of the present disclosure, particles of at least one metal oxide, e.g. second and/or first particles, may be selected from the group consisting of oxide ceramic materials such as aluminum oxide (Al₂O₃), beryllium oxide (BeO), calcium oxide (CaO), hafnium oxide (HfO₂), iron oxide (FeO/Fe₂O₃), lanthanum oxide (La₂O₃), magnesium oxide (MgO), manganese oxide (MnO₂), silicon dioxide (SiO₂), strontium oxide (SrO), thorium oxide (ThO₂), titanium dioxide (TiO₂), yttrium oxide (Y₂O₃), zirconium dioxide (ZrO₂) and mixtures thereof.

In preferred embodiments, the particles of the at least one metal oxide are selected from particles from the group consisting of aluminum oxide (Al₂O₃), silicone dioxide (SiO₂), titanium dioxide (TiO₂), zirconium dioxide (ZrO₂) and mixtures thereof.

In the sense of the present disclosure, particles of at least one metal carbide, e.g. first particles, may be selected from the group consisting of silicon carbide (SiC), tungsten carbide (WC), boron carbide (B₄C), and mixtures thereof.

In preferred embodiments, the particles of the at least one metal carbide may be silicon carbide (SiC).

In the sense of the present disclosure, particles of at least one metal nitride, e.g. first particles, may be selected from the group consisting of silicon nitride (Si₃N₄), aluminum nitride (AlN), titanium nitride (TiN), boron nitride (BN), and mixtures thereof.

In preferred embodiments, the particles of the at least one metal nitride may be selected from the group consisting of silicon nitride (Si₃N₄), aluminum nitride (AlN), titanium nitride (TiN), and mixtures thereof.

In the sense of the present disclosure, the mean pore size is regarded to as the D₉₀ of the pore size, i.e. the size of the pores, wherein the portion of pores with diameters smaller than or equal to this value is 90% with respect to the total number of pores.

Where the term “comprising” is used in the present disclosure and claims, it does not exclude other elements. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

The Support Structure

According to the present disclosure, the support is formed by a porous material to allow liquids to pass through. The support is formed by a ceramic material. In one embodiment, the support is formed of a metal oxide ceramic material. In another embodiment, the support is formed by a non-oxide ceramic material, e.g. one or more metal carbides or one or more metal nitrides.

In a preferred embodiment, the support has a mean pore size ≤30 μm. In another preferred embodiment, the mean pore size may optionally be reduced to a mean pore size ≤1.5 μm through the coating of at least one support layer to reduce the mean pore size in a stepwise manner. In this case, the optionally coated support layer is regarded to as the support structure for the present disclosure. The reduction of the pore size of the support through coating of a support layer may result in a lower rate of defects in the filtration layer.

The support may have different shapes. No particular limitation is imposed on the shape of the support. Similarly, no particular limitation is imposed on the shape of the filtration layer which is supported on/in direct contact to the support structure. For example, the support may have the shape of a disk, a polygonal plate, a plate, a flat sheet, a cylinder, a box-like cylinder, a rod, a square pillar, etc. which may be selected in respect of the purpose of use. No limitation is imposed on the dimensions of the support or filtration layer, except for their thickness, and the dimensions may be selected in respect of the purpose of use, as long as the dimensions assure sufficient strength of the support. The person skilled in the art choses the thickness and material of the support in a way to provide the filtration element with a sufficient mechanical strength for the purpose of use.

The First Particles

In one embodiment of the present disclosure, the first particles may be selected from the group consisting of metal carbides. In another embodiment, the first ceramic nanoparticle is selected from the group consisting of SiC, WC, B₄C, and mixtures thereof. In another preferred embodiment, the first particles may be selected from the group consisting of SiC, WC, and mixtures thereof. In another preferred embodiment, the first particles may be selected particles of SiC.

In another embodiment, the first particles may be selected from the group consisting of metal nitrides. In another embodiment, the first particles may be selected from the group consisting of Si₃N₄, BN, AlN, TiN, and mixtures thereof. In another embodiment, the first particles may be selected from the group consisting of Si₃N₄, AlN, TiN, and mixtures thereof. In a preferred embodiment, the first particles may be selected from the group consisting of AlN, TiN, and mixtures thereof. In another preferred embodiment, the first particle may be AlN.

In another embodiment, the first particle may be selected from the group consisting of metal oxides. In another embodiment, the first particle may be selected from the group consisting of Al₂O₃, BeO, CaO, HfO₂, FeO, Fe₂O₃, La₂O₃, MgO, MnO₂, SiO₂, SrO, ThO₂, TiO₂, Y₂O₃, ZrO₂, and mixtures thereof. In another preferred embodiment, the first particle may be selected from the group consisting of Al₂O₃, SiO₂, TiO₂, ZrO₂, and mixtures thereof. In another preferred embodiment, the first particle may be selected from the group consisting of Al₂O₃, TiO₂, and ZrO₂.

In one embodiment, the first particles have a mean diameter D₅₀ of from 10 nm to 15 μm. In another embodiment, the first particles have a diameter D₅₀ of from 10 nm to 13 μm. In a preferred embodiment, the first particles have a diameter D₅₀ of from 10 nm to 10 μm. In another preferred embodiment, the first particles have a diameter D₅₀ of from 10 nm to 7 μm. In another preferred embodiment, the first particles have a diameter D₅₀ of from 10 nm to 5 μm. In another preferred embodiment, the first particles have a diameter D₅₀ of from 10 nm to 4 μm. In another preferred embodiment, the first particles have a diameter D₅₀ of from 10 nm to 3 μm. In a preferred embodiment, the first particles have a mean diameter D₅₀ of from 20 nm to 2 μm. In another preferred embodiment, the first particles have a mean diameter D₅₀ of from 50 nm to 1.75 μm. In another preferred embodiment, the first particles have a mean diameter D₅₀ of from 100 nm to 1.5 μm. In another preferred embodiment, the first particles have a mean diameter D₅₀ of from 100 nm to 1 μm.

In another embodiment, the first particles additionally have a diameter D₉₀ in the range of from 20 nm to 50 μm. In another embodiment, the first particles have a diameter D₉₀ in the range of from 20 nm to 40 μm. In another embodiment, the first particles have a diameter D₉₀ in the range of from 20 nm to 30 μm. In another embodiment, the first particles have a diameter D₉₀ in the range of from 20 nm to 25 μm. In another embodiment, the first particles have a diameter D₉₀ in the range of from 20 nm to 20 μm. In another embodiment, the first particles have a diameter D₉₀ in the range of from 20 nm to 15 μm. In another embodiment, the first particles have a diameter D₉₀ in the range of from 20 nm to 10 μm. In another embodiment, the first particles have a diameter D₉₀ in the range of from 20 nm to 6 μm. In a preferred embodiment, the first particles have a diameter D₉₀ in the range of from 100 nm to 5,000 nm. In a preferred embodiment, the first particles have a diameter D₉₀ in the range of from 200 nm to 4,000 nm. In a preferred embodiment, the first particles have a diameter D₉₀ in the range of from 250 nm to 3,000 nm. In a preferred embodiment, the first particles have a diameter D₉₀ in the range of from 300 nm to 2,500 nm. In a preferred embodiment, the first particles have a diameter D₉₀ in the range of from 400 nm to 2,500 nm. In a preferred embodiment, the first particles have a diameter D₉₀ in the range of from 500 nm to 2,500 nm. In a preferred embodiment, the first particles have a diameter D₉₀ in the range of from 500 nm to 2,000 nm.

In another embodiment, the first particles have a diameter D₅₀ of from 10 nm to 15 μm, preferably from 10 nm to 13 μm, further preferably from 10 nm to 10 μm, further preferably from 10 nm to 7 μm, further preferably from 10 nm to 5 μm, further preferably from 10 nm to 4 μm, further preferably from 10 nm to 3,000 nm, preferably of from 20 nm to 2,000 nm, more preferably of from 50 nm to 1,750 nm, more preferably of from 100 nm to 1,500 nm, most preferably of from 100 nm to 1,000 nm; and preferably D₉₀ is in the range of from 20 nm to 6,000 nm, more preferably of from 100 nm to 5,000 nm, more preferably of from 200 nm to 4,000 nm, more preferably of from 250 nm to 3,000 nm, more preferably of from 300 nm to 2,500 nm, more preferably of from 400 nm to 2,500 nm, more preferably of from 400 nm to 2,500 nm, most preferably of from 450 nm to 2,000 nm.

In another embodiment, the first particles have a diameter D₅₀ below 15 μm. In another embodiment, the first particles have a diameter D₅₀ below 14 μm. In another embodiment, the first particles have a diameter D₅₀ below 13 μm. In another embodiment, the first particles have a diameter D₅₀ below 12 μm. In another embodiment, the first particles have a diameter D₅₀ below 11 μm. In another embodiment, the first particles have a diameter D₅₀ below 10 μm. In another embodiment, the first particles have a diameter D₅₀ below 9 μm. In another embodiment, the first particles have a diameter D₅₀ below 8 μm. In another embodiment, the first particles have a diameter D₅₀ below 7 μm. In another embodiment, the first particles have a diameter D₅₀ below 6 μm. In another embodiment, the first particles have a diameter D₅₀ below 5 μm. In another embodiment, the first particles have a diameter D₅₀ below 4 μm. In a preferred embodiment, the first particles have a diameter D₅₀ below 3 μm. In another preferred embodiment, the first particles have a diameter D₅₀ below 2,500 nm. In another preferred embodiment, the first particles have a diameter D₅₀ below 2,000 nm. In another preferred embodiment, the first particles have a diameter D₅₀ below 1,500 nm. In another preferred embodiment, the first particles have a diameter D₅₀ below 1,250 nm. In another preferred embodiment, the first particles have a diameter D₅₀ below 1,000 nm. In another preferred embodiment, the first particles have a diameter D₅₀ below 800 nm. In another preferred embodiment, the first particles have a diameter D₅₀ below 700 nm. In another preferred embodiment, the first particles have a diameter D₅₀ below 600 nm.

In another embodiment, the first particles have a diameter D₅₀ above 5 nm. In another embodiment, the first particles have a diameter D₅₀ above 10 nm. In a preferred embodiment, the first particles have a diameter D₅₀ above 15 nm. In another preferred embodiment, the first particles have a diameter D₅₀ above 20 nm. In another preferred embodiment, the first particles have a diameter D₅₀ above 25 nm. In another preferred embodiment, the first particles have a diameter D₅₀ above 30 nm. In another preferred embodiment, the first particles have a diameter D₅₀ above 35 nm. In another preferred embodiment, the first particles have a diameter D₅₀ above 40 nm. In another preferred embodiment, the first particles have a diameter D₅₀ above 45 nm. In another preferred embodiment, the first particles have a diameter D₅₀ above 50 nm. In another preferred embodiment, the first particles have a diameter D₅₀ above 60 nm. In another preferred embodiment, the first particles have a diameter D₅₀ above 70 nm. In another preferred embodiment, the first particles have a diameter D₅₀ above 80 nm. In another preferred embodiment, the first particles have a diameter D₅₀ above 90 nm. In another preferred embodiment, the first particles have a diameter D₅₀ above 100 nm.

In another embodiment, the first particles further have a diameter D₉₀ below 60 μm. In another embodiment, the first particles have a diameter D₉₀ below 50 μm. In another embodiment, the first particles have a diameter D₉₀ below 40 μm. In another embodiment, the first particles have a diameter D₉₀ below 30 μm. In another embodiment, the first particles have a diameter D₉₀ below 25 μm. In another embodiment, the first particles have a diameter D₉₀ below 20 μm. In another embodiment, the first particles have a diameter D₉₀ below 15 μm. In another embodiment, the first particles have a diameter D₉₀ below 10 μm. In another embodiment, the first particles have a diameter D₉₀ below 6 μm. In another embodiment, the first particles have a diameter D₉₀ below 5 μm. In another embodiment, the first particles have a diameter D₉₀ below 4 μm. In another embodiment, the first particles have a diameter D₉₀ below 3 μm. In a preferred embodiment, the first particles have a diameter D₉₀ below 2,500 nm. In another preferred embodiment, the first particles have a diameter D₉₀ below 2,000 nm.

In another embodiment, the first particles have a diameter D₉₀ above 10 nm. In another embodiment, the first particles have a diameter D₉₀ above 15 nm. In a preferred embodiment, the first particles have a diameter D₉₀ above 20 nm. In another preferred embodiment, the first particles have a diameter D₉₀ above 30 nm. In another preferred embodiment, the first particles have a diameter D₉₀ above 40 nm. In another preferred embodiment, the first particles have a diameter D₉₀ above 50 nm. In another preferred embodiment, the first particles have a diameter D₉₀ above 70 nm. In another preferred embodiment, the first particles have a diameter D₉₀ above 90 nm. In another preferred embodiment, the first particles have a diameter D₉₀ above 100 nm. In another preferred embodiment, the first particles have a diameter D₉₀ above 150 nm. In another preferred embodiment, the first particles have a diameter D₉₀ above 200 nm. In another preferred embodiment, the first particles have a diameter D₉₀ above 250 nm. In another preferred embodiment, the first particles have a diameter D₉₀ above 300 nm. In another preferred embodiment, the first particles have a diameter D₉₀ above 350 nm. In another preferred embodiment, the first particles have a diameter D₉₀ above 400 nm. In another preferred embodiment, the first particles have a diameter D₉₀ above 450 nm.

It is understood that any of the aforementioned minimum diameters D₅₀ may be combined with any maximum diameter D₅₀ defined in an embodiment given hereinabove under the provision that the selected minimum D₅₀ is smaller than the selected maximum D₅₀.

It is furthermore understood that any of the aforementioned minimum diameters D₉₀ may be combined with any maximum diameter D₉₀ defined in an embodiment given hereinabove under the provision that the selected minimum D₉₀ is smaller than the selected maximum D₉₀.

It is furthermore understood that any of the combinations of D₅₀ diameters may be combined with any combination of D₉₀ diameters under the provision that the D₅₀ diameter is smaller than the D₉₀ diameter.

It is also understood that the first particles determine the pore size and the chemical properties of the filtration layer. The first particles exhibit a low sinter activity, why the presence of second particles is necessary.

The Second Particles

In one embodiment, the second particle may be selected from the group consisting of metal oxides. In another embodiment, the second particle may be selected from the group consisting of Al₂O₃, BeO, CaO, HfO₂, FeO, Fe₂O₃, La₂O₃, MgO, MnO₂, SiO₂, SrO, ThO₂, TiO₂, Y₂O₃, ZrO₂, and mixtures thereof. In another preferred embodiment, the second particle may be selected from the group consisting of Al₂O₃, SiO₂, TiO₂, ZrO₂, and mixtures thereof. In another preferred embodiment, the second particle may be selected from the group consisting of Al₂O₃, TiO₂, and ZrO₂. In another preferred embodiment, the second particle may be ZrO₂.

In one embodiment, the second particles have a mean diameter D₅₀ of from 1 nm to 150 nm. In a preferred embodiment, the second particles have a mean diameter D₅₀ of from 1 nm to 100 nm. In another preferred embodiment, the second particles have a mean diameter D₅₀ of from 1 nm to 50 nm.

In another embodiment, the second particles have a diameter D₉₀ in the range of from 3 nm to 400 nm. In a preferred embodiment, the second particles have a diameter D₉₀ in the range of from 3 nm to 300 nm. In a preferred embodiment, the second particles have a diameter D₉₀ in the range of from 5 nm to 200 nm. In a preferred embodiment, the second particles have a diameter D₉₀ in the range of from 5 nm to 100 nm.

In another embodiment, the second particles have a diameter D₅₀ of from 1 nm to 150 nm, preferably of from 1 nm to 100 nm, further preferably of from 1 nm to 50 nm, and preferably D₉₀ is in the range of from 3 nm to 400 nm, further preferably of from 3 nm to 300 nm, more preferably of from 5 nm to 200 nm, most preferably of from 5 nm to 100 nm.

In another embodiment, the second particles have a Z-ratio of below 20. In another embodiment, the second particles have a Z-ratio of below 15. In another embodiment, the second particles have a Z-ratio of below 10. In a preferred embodiment, the second particles have a Z-ratio of from 1 to 7. In another preferred embodiment, the second particles which are TiO₂ particles have a Z-ratio of from 1 to 5. In another preferred embodiment, the second particles which are ZrO₂ particles have a Z-ratio of from 1 to 3. It is understood from the formula for the calculation of the Z-ratio that the Z-ratio cannot be smaller than 1.

It is understood that small particles of metal oxides have a high sinter activity. Therefore, the second particles have the ability to bond the larger first particles together even at comparably low sinter temperatures and thereby increase the stability of the filtration layer without influencing the pore size or the chemical properties, such as the zeta potential, of the filtration membrane. In other words, the second particles bind the first particles together which provides the filtration elements according to the present application with a high mechanical strength despite the low sintering temperature.

It is understood that the use of second particles being metal oxides, such as Al₂O₃, TiO₂, ZrO₂, SiO₂, and the like provide for a high chemical and mechanical stability of the filtration element. Second particles of pure metal oxides are hence superior over particles of clay, mullite and the like. Furthermore, it is understood that clay, mullite and the like are not available in a particle size of D₉₀ below 400 nm as required for the present disclosure.

The Filtration Layer

According to the present disclosure, the filtration layer comprises at least two different ceramic particles, i.e. first particles and second particles, and so forth. In one embodiment, the different particles may differ at least in their size expressed by their numerical D₅₀ values. In another embodiment, the different particles may optionally differ in their chemical composition.

In a further preferred embodiment, the ceramic filtration layer comprises or consists of two different ceramic nanoparticles, i.e. first particles and second particles.

First Particles Selected from the Group of Metal Carbides or Metal Nitrides

In one embodiment, the filtration layer comprises first particles selected from the group of metal carbides or metal nitrides.

In one embodiment, the filtration layer comprises at least first selected from the group of metal carbides or metal nitrides and second particles, wherein the ratio Y is in the range of from 2 to 5,000. In a preferred embodiment, the ratio Y is in the range of from 5 to 4,000. In another preferred embodiment, the Y ratio is in the range of from 5 to 3,000. In another preferred embodiment, the Y ratio is in the range of from 5 to 2,000. In another preferred embodiment, the Y ratio is in the range of from 5 to 1,000. In another preferred embodiment, the Y ratio is in the range of from 10 to 500. In a preferred embodiment, the ratio Y is in the range of from 50 to 400. In another preferred embodiment, the ratio Y is in the range of from 100 to 300. In another preferred embodiment, the ratio Y is in the range of from 150 to 250.

In another embodiment, the ratio Y is below 5,000. In another preferred embodiment, the ratio Y is below 4,000. In another preferred embodiment, the ratio Y is below 3,000. In another preferred embodiment, the ratio Y is below 2,000. In another preferred embodiment, the ratio Y is below 3,000. In another preferred embodiment, the ratio Y is below 1,500. In another preferred embodiment, the ratio Y is below 1,000. In another preferred embodiment, the ratio Y is below 800. In another preferred embodiment, the ratio Y is below 600. In another embodiment, the ratio Y is below 500. In another preferred embodiment, the ratio Y is below 400. In another preferred embodiment, the ratio Y is below 300. In another preferred embodiment, the ratio Y is below 250.

In another embodiment, the ratio Y is in the range is above 1. In another preferred embodiment, the ratio Y is above 10. In another preferred embodiment, the ratio Y is above 50. In another preferred embodiment, the ratio Y is above 100. In another preferred embodiment, the ratio Y is above 150.

It is understood that any minimum Y ratio given above may be combined with any maximum Y ratio given above.

First Particles Selected from the Group of Metal Oxides

In another embodiment, the filtration layer comprises first particles selected from the group of metal oxides and second particles.

In one embodiment, the filtration layer comprises at least first selected from the group of metal oxides and second particles, wherein the ratio Y is in the range of from 2 to 5,000. In a preferred embodiment, the ratio Y is in the range of from 2 to 4,000. In another preferred embodiment, the Y ratio is in the range of from 2 to 3,000. In another preferred embodiment, the Y ratio is in the range of from 2 to 2,000. In another preferred embodiment, the Y ratio is in the range of from 2 to 1,000. In another preferred embodiment, the Y ratio is in the range of from 2 to 500. In a preferred embodiment, the ratio Y is in the range of from 2 to 300. In another preferred embodiment, the ratio Y is in the range of from 3 to 200. In another preferred embodiment, the ratio Y is in the range of from 5 to 100.

In another embodiment, the ratio Y is below 5,000. In another preferred embodiment, the ratio Y is below 4,000. In another preferred embodiment, the ratio Y is below 3,000. In another preferred embodiment, the ratio Y is below 2,000. In another preferred embodiment, the ratio Y is below 1,500. In another preferred embodiment, the ratio Y is below 1,000. In another preferred embodiment, the ratio Y is below 500. In another preferred embodiment, the ratio Y is below 600. In another embodiment, the ratio Y is below 500. In another preferred embodiment, the ratio Y is below 300. In another preferred embodiment, the ratio Y is below 200. In another preferred embodiment, the ratio Y is below 150. In another preferred embodiment, the ratio Y is below 100.

In another embodiment, the ratio Y is in the range is above 1. In another preferred embodiment, the ratio Y is above 2. In another preferred embodiment, the ratio Y is above 3. In another preferred embodiment, the ratio Y is above 4. In another preferred embodiment, the ratio Y is above 5.

It is understood that any minimum Y ratio given above may be combined with any maximum Y ratio given above.

Composition of Filtration Layer

In one embodiment, the first and second particles show a bi modal numerical distribution of particle size. In other words, the first and second particles each have a numerical particle size distribution which overlaps only partially, wherein the intersection of both particle size distributions is not at the maximum of particle numbers of any of the particle size distribution. In a preferred embodiment, the D₁₀ of the first particles is larger than the D₉₀ of the second particles. In another preferred embodiment, the particle size distributions do not overlap.

In one embodiment, the filtration layer comprises second particles in an amount of from 1 wt.-% to 50 wt.-% based on the total weight of the first and second particles. In a preferred embodiment, the filtration layer comprises second particles in an amount of from 5 wt.-% to 40 wt.-% based on the total weight of the first and second particles. In a preferred embodiment, the filtration layer comprises second particles in an amount of from 5 wt.-% to 35 wt.-% based on the total weight of the first and second particles. In a preferred embodiment, the filtration layer comprises second particles in an amount of from 7 wt.-% to 35 wt.-% based on the total weight of the first and second particles. In a preferred embodiment, the filtration layer comprises second particles in an amount of from 10 wt.-% to 30 wt.-% based on the total weight of the first and second particles.

It is understood that the skilled person can choose the amount of second particles with respect to the amount of first particles individually for every filtration layer depending on the requirements of use. A higher amount of second particles increases the mechanical strength and abrasion stability of the filtration layer. On the other hand, the chemical properties, e.g., the zeta potential, and/or the pore size may be influenced in a negative manner possibly resulting in different filtration properties and/or in a bi-modal distribution of pore size. This may result in an increased risk of membrane blocking and membrane fouling and/or decreased filtrate quality. A lower amount of second particles may decrease the mechanical strength and abrasion stability of the filtration layer because the bonding between the first particles obtained during the sintering process is insufficient. Therefore, the durability may be significantly reduced.

In one embodiment, the filtration layer comprises first and second particles, wherein the first particle is SiC and the second particle is ZrO₂. In another embodiment, the filtration layer comprises first and second particles, wherein the first particle is SiC and the second particle is TiO₂. In another embodiment, the filtration layer comprises first and second particles, wherein the first particle is SiC and the second particle is Al₂O₃. In another embodiment, the filtration layer comprises first and second particles, wherein the first particle is AlN and the second particle is Al₂O₃. In another embodiment, the filtration layer comprises first and second particles, wherein the first particle is AlN and the second particle is ZrO₂. In another embodiment, the filtration layer comprises first and second particles, wherein the first particle is AlN and the second particle is TiO₂. In another embodiment, the filtration layer comprises first and second particles, wherein the first particle is Si₃N₄ and the second particle is Al₂O₃. In another embodiment, the filtration layer comprises first and second particles, wherein the first particle is Si₃N₄ and the second particle is ZrO₂. In another embodiment, the filtration layer comprises first and second particles, wherein the first particle is Si₃N₄ and the second particle is TiO₂. In another embodiment, the filtration layer comprises first and second particles, wherein the first particle is BN and the second particle is Al₂O₃. In another embodiment, the filtration layer comprises first and second particles, wherein the first particle is BN and the second particle is TiO₂. In another embodiment, the filtration layer comprises first and second particles, wherein the first particle is BN and the second particle is ZrO₂. In a preferred embodiment, the filtration layer comprises first and second particles, wherein the first particle is SiC and the second particle is ZrO₂. In another preferred embodiment, the filtration layer comprises first and second particles, wherein the first particle is SiC and the second particle is TiO₂. In another preferred embodiment, the filtration layer comprises first and second particles, wherein the first particle is SiC and the second particle is Al₂O₃. In a more embodiment, the filtration layer comprises first and second particles, wherein the first particle is SiC and the second particle is ZrO₂.

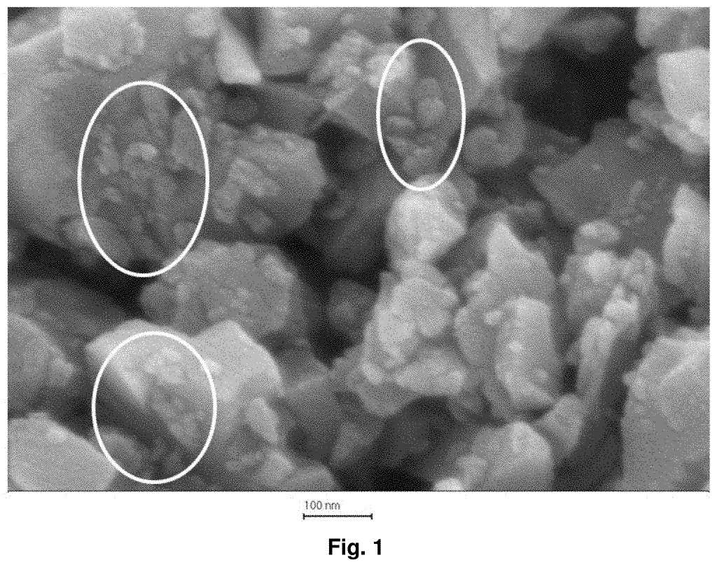

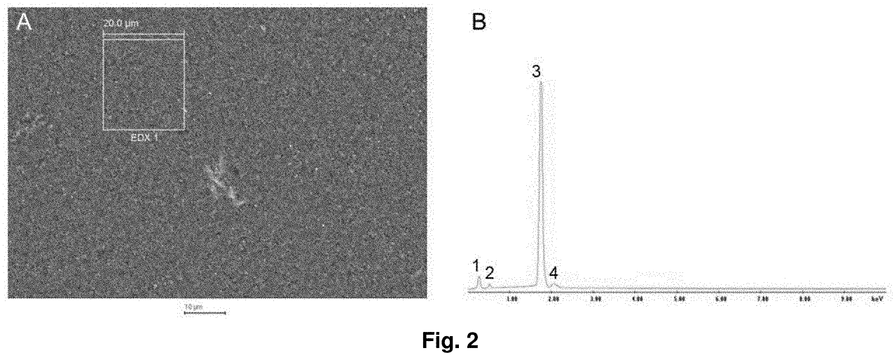

It is understood that the size of the particles comprised in the filtration layer may be determined, e.g. by raster electron microscopy (REM, cf. FIG. 1), after their preparation. Furthermore, it is understood that the chemical composition of the filtration layer may be determined after their preparation, e.g. by elemental analysis by Energy Dispersive X-Ray Analysis (cf. FIG. 2, portion B).

FIG. 1 shows a magnified REM image of a filtration layer comprising SiC particles as first particles and 30 wt.-% of ZrO₂ particles as second particles which bind to the larger SiC particles and bind them together (white circles). Detector=InLens; Signal B=MPSE; Signal=1.0000; EHT=5.00 kV; Mag=250.00 KX; WD=4.0 mm; Image recorded on a Zeiss Leo 15340VP.

FIG. 2 shows a REM image of the same filtration element (in portion A) from which an EDX analysis was performed (in portion B). 1: peak for C K; 2: peak for O K; 3: peak for Si K; 4: peak for Zr L. A: Detector=InLens; Signal B=MPSE; Signal=1.0000; EHT=5.00 kV; Mag=250.00 KX; WD=4.0 mm; Image recorded on a Zeiss Leo 15340VP. B: integrated EDX detector from Zeiss LEO 15340VP.

Additionally, it is understood that the selection of first particles determines the filtration properties of the filtration element. The person skilled in the art can choose the first particles with respect to the intended use of the filtration element.

For example, the pore size and thus the molecular cutoff weight are determined by the first particles. The larger the diameter D₅₀ of the first particles, the larger the size of the pores.

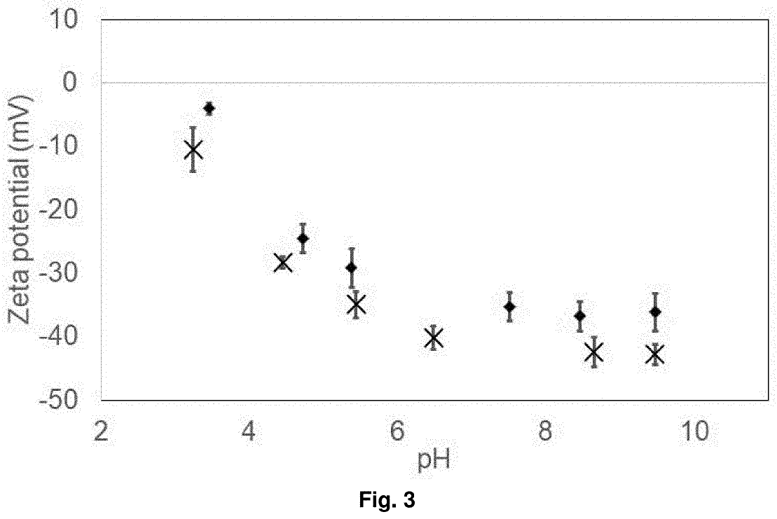

Furthermore, also the zeta potential of the surface of the filtration layer is determined by the choice of first particles. It is known that filtration layers consisting of particles of metal carbides exhibit a typical course of the zeta potential over the range of different pH values, whereas the isoelectric point is in the pH-range of from 2 to 3 (cf. FIG. 3). Therefore, the surface of said filtration layers is charged negatively over a broad pH-range, i.e. above 3. This is highly desirable in a variety of filtration task, as negatively charged (organic) compounds are repelled. Therefore, not only the retention of such compounds is improved, but also the tendency of membrane fouling, e.g. the formation of a fouling layer comprising particles and molecules from the feed on top of the filtration layer) is reduced.

FIG. 3 shows the slope of the zeta potential in relation to the pH value. Therein, two different elements have been analyzed, both of which comprise SiC as first particles and ZrO₂ as second particles. Diamonds: filtration element 1 according to Example 1 comprising 30 wt.-% of ZrO₂ as second particles and SiC as first particles. The sintering was performed at 400° C. for 2 h. Cross: filtration element 2 according to Example 1 comprising 30 wt.-% of ZrO₂ as second particles and SiC as first particles. The sintering was performed at 500° C. for 2 h.

These advantageous properties are maintained in the filtration layers according to the present disclosure despite the presence of second particles in the filtration layer.

The Process of Manufacture of Ceramic Filtration Elements

In a second aspect, the present disclosure relates to a process for manufacture of said ceramic filtration elements, wherein the process of manufacture comprises the steps of providing a support structure having a support surface, and a coating suspension comprising the first and second particles, contacting the support surface with the coating suspension for a duration of time, preferably for 10 to 120 seconds, more preferably for 60 seconds or for 30 seconds, removing excess coating suspension without removing a residual film of coating suspension, drying the residual film, preferably for 2 to 6 h at a temperature in the range of from 60° C. to 90° C., and sintering the support structure with the residual film, optionally repeating steps b) to e), preferably up to 7 times, more preferably up to 5 times.

The present disclosure relates to a method for the production of the ceramic filtration elements described above. Accordingly, a second aspect of the present disclosure relates to a process for manufacturing a multilayer ceramic filtration element according to the first aspect as detailed above, wherein the layers are formed by application of a suspension comprising first and second to a ceramic support structure which is solidified by sintering at low temperature without the requirement of an inert atmosphere.

In the sense of the present disclosure, excess coating suspension is the amount of coating suspension which does not stick to the solid surface to be coated by means of adhesive forces. The coating suspension being carefully removed is also referred to as the excess coating suspension. Thus, a film of the coating suspension sticks to the surface to be coated through adhesion forces while the coating suspension not sticking to the surface is removed gently.

An advantage of the process for the manufacture of a ceramic filtration element according to the present disclosure is the cost saving and simplification of the process through reducing the requirements as regards temperature and atmosphere.

The process for the preparation of a ceramic filtration element according to the present disclosure comprises the following steps (a) to (f):

(a) For the coating of the filtration layer, a coating suspension is provided in a first step. The coating suspension may be prepared from crystalline powders of first and second particles and a solvent in the presence of a dispersion additive. Optionally, a bonding agent may be comprised in the coating suspension.

It is understood that the use of crystalline powders of first and second particles is essential for the process and filtration elements according to the present disclosure. Therefore, processes like sol-gel process are excluded. When a sol-gel process is used instead of a crystalline powder of second particles, the extent to which a metal oxide is formed on the surface of the first particles during firing cannot be controlled. In other words, a sol of metal oxide precursor readily covers the entire surface of the first particles. During transformation of the precursor into a metal oxide, the first particles might be bound together. However, the entire surface of the first particles is covered with metal oxide. Therefore, the properties of a filtration element such as the Zeta potential are exclusively determined by the metal oxide. It is hence impossible to prepare filtration elements having the advantageous properties of non-oxide ceramic filtration elements set out hereinabove by using a sol-gel process or the like.

In one embodiment, the coating suspension comprises a dispersion additive to facilitate optimal mixing and prevent accelerated aggregation of the particles. The dispersion additive may be selected from the group of surfactants, e.g. carbonic acids, fatty alcohols, mineral acids, ammonium salts such as tetramethyl ammonium hydroxide, or polyelectrolytes, such as poly(sodium styrene sulfonate). In a preferred embodiment, the dispersion additive is selected from the group consisting of mineral acids. In another preferred embodiment, the dispersion additive is nitric acid. In another preferred embodiment, the dispersion additive is hydrochloric acid. In another preferred embodiment, the dispersion additive is selected from the group consisting of carbonic acids. In another preferred embodiment, the dispersion additive is acetic acid. In another preferred embodiment, the dispersion additive is tetramethyl ammonium hydroxide.

In one embodiment, the coating suspension comprises a dispersion additive in an amount of up to 5 wt.-%. In another embodiment, the coating suspension comprises a dispersion additive in an amount of up to 3 wt.-%. In a preferred embodiment, the coating suspension comprises a dispersion additive in an amount of from 0.1 wt.-% to 3 wt.-%. In another preferred embodiment, the coating suspension comprises a dispersion additive in an amount of from 0.1 wt.-% to 1 wt.-%.

Furthermore, a bonding agent may be added to facilitate sintering and enhance the strength of bonding. This bonding agent may be selected from a polymer, especially a polyvinyl alcohol, a polyvinyl pyrrolidone, or a cellulose, or a mixture thereof. In a preferred embodiment, the bonding agent is a polyvinyl alcohol. In another preferred embodiment, the cellulose is selected from a methyl cellulose, and a carboxymethyl cellulose, or mixtures thereof.

In another embodiment, a bonding agent is present in an amount of 15 wt.-% based on the total weight of the coating suspension, preferably in an amount of 10 wt.-% based on the total weight of the coating suspension. In another embodiment, the bonding agent is present in an amount of at least 0.5 wt.-% based on the total weight of the coating suspension. In another preferred embodiment, the bonding agent is present in an amount of from 0.5 wt.-% to 15 wt.-% based on the total weight of the coating suspension. In another preferred embodiment, the bonding agent is present in an amount of from 0.5 wt.-% to 10 wt.-% based on the total weight of the coating suspension. In another preferred embodiment, the bonding agent is present in an amount of from 0.5 wt.-% to 5 wt.-% based on the total weight of the coating suspension.

In one embodiment, the coating suspension for the coating of the filtration layer comprises second particles in an amount of from 1 wt.-% to 50 wt.-% based on the total weight of the first and second particles. In a preferred embodiment, the coating suspension comprises second particles in an amount of from 5 wt.-% to 40 wt.-% based on the total weight of the first and second particles. In a preferred embodiment, the coating suspension comprises second particles in an amount of from 5 wt.-% to 30 wt.-% based on the total weight of the first and second particles. In a preferred embodiment, the coating suspension comprises second particles in an amount of from 7 wt.-% to 25 wt.-% based on the total weight of the first and second particles. In a preferred embodiment, the coating suspension comprises second particles in an amount of from 10 wt.-% to 25 wt.-% based on the total weight of the first and second particles.

In one embodiment, the coting suspension comprises a mixture of first and second particles as described above in an amount of from 1 wt.-% to 40 wt.-% based on the total weight of the coating suspension. In a preferred embodiment, the coating suspension comprises a mixture of first and second particles as described above in an amount of from 2 wt.-% to 35 wt.-%. In another preferred embodiment, the coating suspension comprises a mixture of first and second particles as described above in an amount of from 3 wt.-% to 30 wt.-%. In another preferred embodiment, the coating suspension comprises a mixture of first and second particles as described above in an amount of from 5 wt.-% to 25 wt.-%. In another preferred embodiment, the coating suspension comprises a mixture of first and second particles as described above in an amount of from 5 wt.-% to 20 wt.-%. In another preferred embodiment, the coating suspension comprises a mixture of first and second particles as described above in an amount of from 7 wt.-% to 15 wt.-%.

In one embodiment, the coating suspension may comprises at least 1 wt.-% of the first particle, based on the total weight of the suspension, preferably the coating suspension may comprise of from 1 wt.-% to 70 wt.-% of the first particle, preferably of from 1 wt.-% to 50 wt.-% of the first particle, more preferably of from 1 wt.-% to 30 wt.-% of the first particle, more preferably wherein the coating suspension may comprise of from 3 wt.-% to 20 wt.-% of the first particle, most preferably wherein the coating suspension may comprise of from 5 wt.-% to 15 wt.-% of the first particle based on the total weight of the coating suspension.

In one embodiment, the coating suspension may comprise at least 0.1 wt.-% of the second particle based on the total weight of the mixture, preferably the coating suspension may comprise of from 0.1 wt.-% to 35 wt.-% of the second particle, preferably of from 0.1 wt.-% to 25 wt.-% of the second particle, more preferably of from 0.1 wt.-% to 15 wt.-%, more preferably of from 0.1 wt.-% to 10 wt.-% of the second particle, more preferably the coating suspension may comprise of from 1 wt.-% to 10 wt.-% of the second particle, most preferably the coating suspension may comprise of from 1 wt.-% to 8 wt.-% of the second particle based on the total weight of the coating suspension.

In one embodiment, the solvent of the coating suspension is water. In another embodiment, the solvent of the coating suspension is selected from aliphatic, linear or branched alcohols comprising one to six carbon atoms. In another embodiment, the solvent comprises DMSO and/or NMP. In a preferred embodiment, the solvent of the coating suspension is water. In another preferred embodiment, the solvent is ethanol. In another preferred embodiment, the solvent is a mixture of water and ethanol. In another preferred embodiment, the solvent is a mixture of water and DMSO. It is understood that the total coating suspension must have a total weight of 100 wt.-%. If not explicitly described otherwise, the solvent constitutes for the weight not specified (e.g. in the examples). It is furthermore understood that the dispersion additives and bonding agents have to be carefully selected to be compatible with the solvent, e.g., soluble and inert/stable.

In one embodiment, the coating suspension may be prepared from base suspensions which comprise a dispersion additive, a solvent, and first or second particles.

The dispersion additive and the solvent comprised in the base suspensions may be the dispersion additives and solvents described above for the coating suspension.

The base suspension may comprise either first or second particles in an amount of from 1 wt.-% to 80 wt.-%. In one embodiment, the base suspension comprises either first or second particles in an amount of from 1 wt.-% to 50 wt.-% based on the total weight of the respective base suspension. In a preferred embodiment, the base suspension comprises either first or second particles in an amount of from 10 wt.-% to 40 wt.-% based on the total weight of the respective base suspension. In another preferred embodiment, the base suspension may comprise either first or second particles in an amount of from 10 wt.-% to 30 wt.-% based on the total weight of the respective base suspension. In another preferred embodiment, the base suspension may comprise either first or second particles in an amount of from 15 wt.-% to 30 wt.-% based on the total weight of the respective base suspension. In another preferred embodiment, the bases suspension comprises first particles in an amount of from 35 wt.-% to 45 wt.-% based on the total weight of the respective base suspension.

In one embodiment, the base suspension comprising first particles may further comprise a dispersion additive in an amount of from 0.1 wt.-% to 5 wt.-% based on the total weight of the base suspension. In another embodiment, the base suspension comprising first particles may further comprise a dispersion additive in an amount of from 0.1 wt.-% to 4 wt.-% based on the total weight of the base suspension. In another embodiment, the base suspension comprising first particles may further comprise a dispersion additive in an amount of from 0.1 wt.-% to 2 wt.-% based on the total weight of the base suspension. In a preferred embodiment, the base suspension comprising first particles may further comprise a dispersion additive in an amount of from 0.1 wt.-% to 2 wt.-% based on the total weight of the base suspension. In another preferred embodiment, the base suspension comprising first particles may further comprise a dispersion additive in an amount of from 0.1 wt.-% to 1 wt.-% based on the total weight of the base suspension.

In one embodiment, the base suspension comprising second particles may further comprise a dispersion additive in an amount of from 1 wt.-% to 20 wt.-% based on the total weight of the base suspension. In another embodiment, the base suspension comprising second particles may further comprise a dispersion additive in an amount of from 1 wt.-% to 15 wt.-% based on the total weight of the base suspension. In another embodiment, the base suspension comprising second particles may further comprise a dispersion additive in an amount of from 1 wt.-% to 10 wt.-% based on the total weight of the base suspension. In a preferred embodiment, the base suspension comprising second particles may further comprise a dispersion additive in an amount of from 2 wt.-% to 10 wt.-% based on the total weight of the base suspension. In another preferred embodiment, the base suspension comprising second particles may further comprise a dispersion additive in an amount of from 3 wt.-% to 7 wt.-% based on the total weight of the base suspension.

In one embodiment, the coating suspension may be prepared by mixing the components comprised therein, e.g., first and second particles, dispersion additive, bonding agent, and solvent.

In another embodiment, the coating suspension may be prepared by mixing the base suspensions comprising first and second nanoparticles with a bonding agent and a solvent.

Mixing may be achieved by input of mechanical energy to obtain a uniform distribution of particles in the coating suspension. Mechanical energy may be applied through stirring, shaking or milling with an energy input of from approximately 0.1 kWh/kg of suspension to approximately 15 kWh/kg of suspension.

(b) In another step of the process of manufacture, the filtration layer is formed through contacting the surface of the support structure with the coating suspension. In a preferred embodiment, support structure is in the shape of a tube. For coating, the tube is arranged vertically and the tube is filled with coating suspension by a pump. In another preferred embodiment, the tube is filled completely.

The coating suspension is contacted to the support surface for a dwell time. In one embodiment, the coating suspension is contacted with the support for a dwell time of less than 120 seconds. In a preferred embodiment, the coating suspension is contacted with the support for a dwell time of up to 60 seconds. In another preferred embodiment, the suspension is contacted with the support for a dwell time of 60 seconds. In another preferred embodiment, the suspension is contacted with the support for a dwell time of 30 seconds. In another embodiment, the suspension is contacted with the support for a dwell time of at least 10 seconds. In a preferred embodiment, the suspension is contacted with the support for a dwell time of from 10 seconds to 120 seconds. In another preferred embodiment, the suspension is contacted with the support for a dwell time of from 10 seconds to 60 seconds. In another preferred embodiment, the suspension is contacted with the support for a dwell time of 30 seconds or 60 seconds.

(c) After the dwell time, the coating suspension is removed carefully, leaving a film on the support. In one embodiment, the suspension is bled out of the tube leaving a film of coating suspension on the surface of the support. The amount of suspension being bled out of the tube is referred to as excess coating suspension. The excess coating suspension comprises the first and second particles which do not adhere to the surface to be coated through adhesive forces. The thickness of the film left on the surface of the support can be controlled by the dwell time through the effect of concentration polarization and the shear forces caused by the velocity of the coating suspension during the drainage from the surface. The first and second particles form a layer on top of the support through interlocking between the particles and adhesion forces which are enhanced by capillary effects of the solid support structure below the film. The layer thickness is controlled by the dwell time and the concentration of particles in the coating suspension.

(d) Afterwards, the residual film of coating suspension is dried. In one embodiment, the film is dried under air atmosphere. In another embodiment, the film is dried under air atmosphere at room temperature. In a preferred embodiment, the film is dried for at least 12 h. In another embodiment, the film is dried at a temperature of from 60° C. to 90° C. under an air atmosphere. In a more preferred embodiment, the film is dried at a temperature of from 60° C. to 90° C. under an air atmosphere for 2 h to 6 h.

The dried film is submitted to a sintering process.

(e) In a next step of the process of manufacture, the dried films are solidified through a sintering step.

The skilled person is aware, that the sintering of films comprising particles of at least one metal carbide or at least one metal nitride usually requires high temperatures of about 2,000° C. Under this conditions, particularly at temperatures above 900° C., metal carbides and metal nitrides are particularly prone to oxidations and rapidly form metal oxides. In other words, it is understood that non-oxide ceramic particles such as SiC, Si₃N₄ or the like as defined hereinabove are susceptible to oxidation at high temperatures of over 900° C., under certain conditions already at 700-800° C., when the atmosphere contains oxygen. This means that a layer of SiO₂ is formed on the surface of the particles in the course of sintering. In other words, the ceramic filtration elements thus obtained contain particles having a non-oxide ceramic compound in the core but an oxide material such as SiO₂ on the surface. It is understood that this oxidation reaction reduces the mechanical and chemical stability of filtration elements thus obtained. Furthermore, the properties of the filtration element is mainly governed by the surface, such as the Zeta potential of the material. Therefore, the sintering of particles of at least one metal carbide or nitride usually requires the exclusion of oxygen, e.g. through replacement of the atmosphere with an inert atmosphere or through applying a vacuum, to prevent oxidation, also referred to “formation of glass” (e.g. when carbides or nitrides of silicone are used) in the sense of the present disclosure.

The inventors of the present disclosure, however, surprisingly found that the sinter temperatures can be substantially reduced to temperatures below the critical temperature of 900° C. due to the high sinter activity of the second particles selected from the group of at least one metal oxide as a consequence of their small size. The second particles may bind the larger first particles together, connecting them in a very strong way and forming a highly durable filtration layer. In addition, the properties of the filtration layer are mainly determined by the inherent properties of the first particles. In this way, only parts of the surface of the first particles are covered with metal oxides. In other words, the surface of the first particles is only covered with a metal oxide surface to the extent that second particles bind to the first particles. The residual surface of the first particles is unchanged and hence determines the properties of the filtration element, such as the Zeta potential.

In one embodiment, wherein the first particles are selected from the group of at least one metal carbide or at least one metal nitride, the step of sintering may be performed at a temperature in the range of from 300° C. to 900 C. In another embodiment, wherein the first particles are selected from the group of at least one metal carbide or at least one metal nitride, the step of sintering may be performed at a temperature in the range of from 400° C. to 900 C. In a preferred embodiment, wherein the first particles are selected from the group of at least one metal carbide or at least one metal nitride, the step of sintering may be performed at a temperature in the range of from 400° C. to 700 C.

It is understood that said metal carbides or metal nitrides do not undergo oxidation at the temperatures described. Therefore, in one embodiment, the sintering step may be conducted under an atmosphere comprising oxygen in an amount below 50% (V/V). In another embodiment, the sintering step may be conducted under an atmosphere comprising oxygen in an amount below 40% (V/V). In another embodiment, the sintering step may be conducted under an atmosphere comprising oxygen in an amount below 30% (V/V). In another preferred embodiment, the step of sintering may be conducted under an atmosphere of air.

In other words, the sintering step according to the present disclosure can be carried out at low temperature and without controlling the atmosphere. Therefore, the process according to the present disclosure offers a cheap and convenient method for the manufacture of ceramic filtration elements, particularly including non-oxide ceramic filtration elements.

In another aspect of the present disclosure, films comprising first particles selected from the group of at least one metal oxide may be sintered at reduced temperature due to the high sinter activity of the second particles which has been described above.

In one embodiment, wherein the first particles are selected from the group of at least one metal oxide, the step of sintering may be performed at a temperature in the range of from 300° C. to 1,400 C. In another embodiment, wherein the first particles are selected from the group of at least one metal oxide, the step of sintering is performed at a temperature in the range of from 300° C. to 1,200 C. In a preferred embodiment, wherein the first particles are selected from the group of at least one metal oxide, the step of sintering is performed at a temperature in the range of from 400° C. to 900 C. In another preferred embodiment, wherein the first particles are selected from the group of at least one metal oxide, the step of sintering is performed at a temperature in the range of from 400° C. to 700 C.

In one embodiment, the step of sintering may be performed at a temperature in the range of from 300° C. to 1,200 C. In another embodiment, the step of sintering is performed at a temperature in the range of from 400° C. to 1,100 C. In a preferred embodiment, the step of sintering is performed at a temperature in the range of from 400° C. to 900 C. In another preferred embodiment, the step of sintering is performed at a temperature in the range of from 400° C. to 700 C.

It is understood that the temperatures described above are substantially lower than the sinter temperatures used so far. Therefore, the process of manufacture according to the present disclosure is improved in that it requires less energy and less efforts with regard to the sinter atmosphere, while the mechanical strength and filtration properties, such as pore size and zeta potential, of the filtration layer are maintained or even improved.

In one embodiment, the filtration elements to be sintered may be heated up to the sinter temperature at a rate of from up to 20° C./min. In another embodiment, the filtration elements to be sintered may be heated up to the sinter temperature at a rate of from up to 15° C./min. In another embodiment, the filtration elements to be sintered may be heated up to the sinter temperature at a rate of from up to 10° C./min. In a preferred embodiment, the filtration elements to be sintered may be heated up to the sinter temperature at a rate of from 1° C./min to 10° C./min. In another preferred embodiment, the filtration elements to be sintered may be heated up to the sinter temperature at a rate of from 1° C./min to 5° C./min.

It is understood that raising the temperature too quickly may result in thermal stress and cracks in the support structure and/or in the filtration layer which may reduce the durability and limit the usability of the filtration elements.

In one embodiment, the filtration elements may be kept at the sinter temperature for a time of from 10 minutes to 600 minutes. In another embodiment, the filtration elements may be kept at the sinter temperature for a time of from 20 to 500 minutes. In another embodiment, the filtration elements may be kept at the sinter temperature for a time of from 20 to 400 minutes. In another embodiment, the filtration elements may be kept at the sinter temperature for a time of from 20 to 300 minutes. In a preferred embodiment, the filtration elements may be kept at the sinter temperature for a time of from 30 to 300 minutes. In another preferred embodiment, the filtration elements may be kept at the sinter temperature for a time of from 30 to 240 minutes.

It is understood that the skilled person selects the time of the sintering step in accordance to the temperature and the sinter activity of the second particles. If the sintering time is chosen too short, the second particles cannot bond the first particles tightly together which results in a low mechanical strength and low stability against chemical stresses of the filtration layer.

In one embodiment, the filtration elements may be cooled down to room temperature after the sintering at a rate of from up to 20° C./min. In one embodiment, the filtration elements may be cooled down to room temperature after the sintering at a rate of from up to 15° C./min. In one embodiment, the filtration elements may be cooled down to room temperature after the sintering at a rate of from up to 10° C./min. In a preferred embodiment, the filtration elements may be cooled down to room temperature after the sintering at a rate of from 1° C./min to 10° C./min. In another preferred embodiment, the filtration elements may be cooled down to room temperature after the sintering at a rate of from 1° C./min to 5° C./min. In another preferred embodiment, the filtration elements may be cooled down to room temperature after the sintering at a rate determined by the oven used without the application of external cooling.

It is understood that a quicker cooling, e.g. by thermo shock cooling, may result in thermal stresses and cracks within the support structure and/or the filtration layer.

The sintering step according to the present disclosure is a solid phase sintering. Solid state sintering occurs when the powder compact is densified wholly in a solid state at the sintering temperature, while liquid phase sintering occurs when a liquid phase is present in the powder compact during sintering. In other words, in solid-state sintering, the composition and sintering temperature are such that no liquid is formed, all densification being achieved by reshaping of the powder. This reshaping, which is most commonly achieved by solid-state diffusion of atoms, is driven by the energy reduction achieved by elimination of the solid-gas interface and its replacement by a solid-solid interface. This process is employed for high-quality technical ceramics. It requires the use of fine powders and high temperatures in order to allow sufficient atom diffusion to bring about consolidation in reasonable times.

In contrast, liquid phase sintering is a sintering technique that uses a liquid phase to accelerate the particle bonding of the solid phase. In addition to rapid initial particle rearrangement due to capillary forces, mass transport through liquid is generally orders of magnitude faster than through solid, enhancing the diffusional mechanisms that drive densification. The liquid phase can be obtained either through melting one component or forming a eutectic or by sintering at a temperature between the liquidus and solidus of a component. Additionally, since the softer phase is generally the first to melt, the resulting microstructure typically consists of hard particles in a ductile matrix, increasing the toughness of an otherwise brittle component. However, liquid phase sintering is inherently less predictable than solid phase sintering due to the complexity added by the presence of additional phases and rapid solidification rates.

(f) In one embodiment, the steps (b) to (d) of the process of manufacture can be repeated with the same suspension obtained in step (a) until the desired thickness of the filtration layer is obtained. In preferred embodiments, all steps (b) to (d) are conducted at least once with the same suspension obtained in step (a). In another preferred embodiment, the steps (b) to (d) of the process are not conducted more than six times. In another preferred embodiment, the steps (b) to (d) are conducted up to four times using the same suspension obtained in step (a).

It is understood that in the second and any further repetition of the steps (b) to (d), the support cannot be coated because there is a layer coated on it during the first or preceding manufacturing cycle. In this cases, an additional layer may be coated onto the already existing layer, wherein it is favorable to obtain a thin filtration layer.

In the sense of the present disclosure, single layers consisting of the same materials with regard to the chemical composition and particle size are regarded to as one layer, i.e. the filtration layer.

### Examples

### Example 1: Preparation of Non-Oxide Ceramic Filter Membrane Through Sintering at Low Temperature

Preparation of Base Solution

Crystalline ceramic nanoparticles are obtained from commercial suppliers or milled until the desired particle size is obtained. The mean particle size is given as the numerical D₁₀, D₅₀ and D₉₀ values which are determined by dynamic light scattering (DLS) prior to coating with a NANO-flex machine (obtained from Microtrac Europe GmbH).

A dispersion additive (e.g. acetic acid or tetramethyl ammonium hydroxide) is mixed with water until a homogeneous solution is obtained. Subsequently, the silicon carbide ceramic powder (D₁₀=280 nm, D₅₀=520 nm, D₉₀=1060 nm; Z=3.8) is added under vigorous stirring. In order to obtain a mechanical dispersion with adequate distribution of particles, mechanical energy is applied by means of a perl mill. The application of milling energy depends on ceramic particle size and is chosen in a range of from 0.1 kWh/kg to 15 kWh/kg of suspension. In this way, a base suspension can be obtained containing a 3/1 mixture of solvent and the crystalline ceramic nanoparticle with regard to their weight ratio (weight (solvent)/weight (nanoparticle)) and dispersion additive.

In a similar way, a base suspension of the oxide ceramic nanoparticle comprising zirconium oxide nanoparticles (D₁₀=2 nm, D₅₀=3 nm, D₉₀=5 nm; Z=2.5; 4/1 mixture of solvent and the crystalline ceramic nanoparticle with regard to their weight ratio (weight (solvent)/weight (nanoparticle)) is prepared.

Coating Suspension

Prior to the process of coating, both base suspensions are diluted with water and a bonding agent is added while stirring. The amount of nanoparticle in the suspension is always expressed in weight-% (wt.-%) unless specified otherwise.

A suitable coating suspension has the following composition:

Solvent: H₂O (42 wt.-%)

SiC base suspension (40 wt.-%)

ZrO₂ base suspension (15 wt.-%)

20 wt.-% aqueous solution of polyvinyl alcohol (3 wt.-%)

Coating on Support

The aforementioned coating suspension is filled into the inside of vertically oriented ceramic support tubes. The solution is left in the support tubes for a time of 60 seconds after which the coating suspension is bled. The remaining film on the inner surface of the tube is left to dry. Afterwards, that the coated tubes can be sintered under the conditions given in Table 1 until sufficient strength is obtained.

Characterization of Ceramic Filter Membranes

Filtration

A dispersion of oil in water (pH 6-8) was prepared. The concentration of oil was set to higher than 5200 ppm and the dispersion was mixed to obtain oil droplets of a size D_{3,50} of approximately 1.4 μm. In this case, D_{3,50} is the volumetric D₅₀ value. In other words, D_{3,50} is defined as the diameter of the particles, wherein the volume of particles with diameters smaller than or equal to this value is 50% with respect to the total volume of particles. The dispersion was pumped through ceramic hollow fibers with SiC/ZrO₂ membrane coating on the inner surface at a cross-flow of 2.0 m/s and a transmembrane pressure of 0.5 bar at a temperature of 40° C.

During the filtration trial, the flow remained constant over 7 days without a backflush indicating the negative surface charge of the filtration layer and low fouling tendency.

In the permeate, less than 1 ppm of oil was found. On the other hand, over 99.9% of the oil was retained in the feed dispersion. This experiment reveals excellent filtration properties of the filtration element.

Zeta Potential

The membranes were further characterized by measuring their zeta potential (cf. FIG. 3) with a SurPASS 3 machine obtained from Anton Paar. For conducting the analysis, deionized water, potassium chloride (purity ≥99.5%, obtained from Roth), a 0.01 N solution of KOH (obtained from roth) as a base and a 0.1 N aqueous solution of HCl (obtained from Roth) were used. The measurement was carried out at room temperature (23-26° C.) and the solution contained KCl at a concentration of 1 mmol/L (conductivity 11 mS/m, Volume 530 mL).

The measurement of the zeta potential reveals that the characteristic shape of the typical curve obtained for silicon carbide was conserved despite the addition of an oxide ceramic nanoparticle as a binding phase (cf. FIG. 3). Therefore, the membranes of the present disclosure have the same low tendency of fouling as compared to non-oxide ceramic filter membranes due to the strongly hydrophilic character of the membranes and the repellant properties for components with a negative charge over a broad range of pH values.

Coating Strength with and without Chemical Impact

The coating strength was measured for membranes coated on the outside of ceramic hollow fibers before and after chemical impact to assess the mechanical properties of the ceramic filter membrane. Chemical impact was applied by means of storing the membranes in a strongly basic solution (pH=14) containing NaOH at 95° C. for a period of 4 days.

Mechanical abrasion was tested by a hand abrasion test, comprising strong rubbing of the membranes with a pointer and thumb.

TABLE 1
Results of hand abrasion testing of ceramic membrane coatings on
ceramic hollow fibers (outside) before chemical impact

| Sinter | Coating strength | | | | | |
|---|---|---|---|---|---|---|
| temperature | 400° C. | 500° C. | 600° C. | 700° C. | 800° C. | 900° C. |
| SiC | − − − | − − − | − − − | − − − | − − − | + + |
| (comparative | | | | | | |
| membrane) | | | | | | |
| SiC/ZrO₂ | + + | + + + | + + + | + + + | + + + | + + + |
| (15 wt.-%) | | | | | | |
| SiC/ZrO₂ | + + + | + + + | + + + | + + + | + + + | + + + |
| (30 wt.-%) | | | | | | |
| SiC/TiO₂ | − − | + | + | + + | + + + | + + + |
| (15 wt.-%) | | | | | | |

TABLE 2
Results of hand abrasion testing of ceramic membrane coatings on
ceramic hollow fibers (outside) after chemical impact

| Sinter | Coating strength | | | | | |
|---|---|---|---|---|---|---|
| temperature | 400° C. | 500° C. | 600° C. | 700° C. | 800° C. | 900° C. |
| SiC | n.d. | − − − | n.d. | − − − | n.d. | − − − |
| (comparative | | | | | | |
| membrane) | | | | | | |
| SiC/ZrO₂ | + | + | + | − | n.d. | − − − |
| (15 wt.-%) | | | | | | |
| SiC/ZrO₂ | + + + | + + + | + + + | + + + | + + + | + + + |
| (30 wt.-%) | | | | | | |
| SiC/TiO₂ | n.d. | − − | − − | − − | n.d. | − − − |
| (15 wt.-%) | | | | | | |

n.d.=not determined; - - -: very low coating strength, coating can be completely rubbed off easily; - -: low coating strength, coating can partially be rubbed off easily; -: low coating strength, coating can partially be rubbed off using low pressure; +: medium coating strength, coating can partially be rubbed off using high pressure; ++: high coating strength, coating can be rubbed to a minor amount using high pressure; +++: very high coating strength, coating cannot be rubbed off despite using very high pressure. Numbers given in wt.-% express the amount of second particle based on the total weight of first and second particles. SiC powder used has D₁₀=280 nm, D₅₀=520 nm, D₉₀=1060 nm; ZrO₂ powder used has D₁₀=2 nm, D₅₀=3 nm, D₉₀=5 nm; TiO₂ powder used has D₁₀=12-17 nm, D₅₀=17-22 nm, D₉₀=25-35 nm.

The hand abrasion test reveals that the membranes of the present disclosure have a much higher stability against mechanic stress than membranes prepared from silicon carbide alone. Thereby, the sintering temperature is significantly reduced for the membranes of the present disclosure as compared to the comparative membrane. Even after a strong chemical impact, the membranes of the present disclosure show a good mechanical strength indicating their durability and high relevance for filtration purposes, especially in corrosive media.

### Example 2: Preparation of Oxide Ceramic Filter Membrane Through Sintering at Low Temperature

Crystalline ceramic oxide particles are obtained from commercial suppliers or milled until the desired particle size and shape is obtained. The mean particle size is given as the numerical D₁₀, D₅₀ and D₉₀ values which are determined by DLS prior to coating.

A dispersion additive (i.e. acetic acid) is mixed with water until a homogeneous solution is obtained. Subsequently, an Al₂O₃ powder (D₁₀=140 nm, D₅₀=250 nm, D₉₀=450 nm; Z=3.2) is added under vigorous stirring. In order to obtain a mechanical dispersion with adequate distribution of particles, mechanical energy is applied by means of a pearl mill. The application of milling energy depends on ceramic particle size and is chosen in a range of from 0.1 kWh/kg to 15 kWh/kg of suspension. In this way, a base suspension can be obtained containing a 3/2 mixture of solvent and the crystalline ceramic nanoparticle with regard to their weight ratio (weight (solvent)/weight (nanoparticle)) and dispersion additive.

In a similar way, a base suspension of the oxide ceramic nanoparticle comprising zirconium oxide nanoparticles (D₁₀=2 nm, D₅₀=3 nm, D₉₀=5 nm; Z=2.5; 4/1 mixture of solvent and the crystalline ceramic nanoparticle with regard to their weight ratio (weight (solvent)/weight (nanoparticle)), or titanium oxide nanoparticles (referred to as TiO₂−1; D₁₀=14 nm, D₅₀=18 nm, D₉₀=28 nm; Z=2; 4/1 mixture of solvent and the crystalline ceramic nanoparticle with regard to their weight ratio (weight (solvent)/weight (nanoparticle)) or titanium oxide nanoparticles (referred to as TiO₂-2; D₁₀=29 nm, D₅₀=38 nm, D₉₀=59 nm; Z=2; 4/1 mixture of solvent and the crystalline ceramic nanoparticle with regard to their weight ratio (weight (solvent)/weight (nanoparticle)) are prepared.

Coating Suspension

Prior to the process of coating, both base suspensions are diluted with water and a bonding agent is added while stirring as exemplified by the following composition:

Solvent (H₂O): 66.0 wt.-%

Base suspension (Al₂O₃): 25.0 wt.-%

Base suspension (ZrO₂): 6.0 wt.-%

Bonding agent (20 wt.-% polyvinyl alcohol in H₂O): 3.0 wt.-%

Coating on Support

The aforementioned coating suspension is filled into the inside of vertically oriented ceramic support tubes. The solution is left in the support tubes for a time of 60 seconds after which the coating suspension is bled. The remaining film on the inner surface of the tube is left to dry. Afterwards, that the coated tubes can be sintered until sufficient strength is obtained.

Characterization of Oxide Ceramic Filter Membranes

Measurement of Pore Size

The pore size D₉₀ was determined as 30 to 40 nm by flow porometry. Although filtration elements of this class do not exhibit lower tendency of fouling, the filtration elements can be manufactured easily and at low energy consumption.

Coating Strength without Chemical Impact

Furthermore, the filtration layer shows an improved mechanical strength and abrasion stability. Mechanical abrasion was tested by a hand abrasion test, comprising strong rubbing of the membranes with a pointer and thumb.

TABLE 3
Results of hand abrasion testing of
oxide ceramic membrane coatings

| Sinter temperature | 500° C. | 600° C. | 700° C. | 900° C. |
|---|---|---|---|---|
| Al₂O₃ | − − − | − − − | − − − | + + |
| (comparative | | | | |
| membrane) | | | | |
| Al₂O₃/ZrO₂ | + | + + + | + + + | + + + |
| (12 wt.-%) | | | | |
| Al₂O₃/TiO₂-1 | − | + + | + + + | + + + |
| (12 wt.-%) | | | | |
| Al₂O₃/TiO₂-2 | − | + | + + | + + + |
| (12 wt.-%) | | | | |

− − −: very low coating strength, coating can be completely rubbed off easily;
− −: low coating strength, coating can partially be rubbed off easily;
−: low coating strength, coating can partially be rubbed off using low pressure;
+: medium coating strength, coating can partially be rubbed off using high pressure;
+ +: high coating strength, coating can be rubbed off to a minor amount using high pressure;
+ + +: very high coating strength, coating cannot be rubbed off despite using very high pressure.
Numbers given in wt.-% express the amount of second particle based on the total weight of first and second particles. Al₂O₃ powder used has D₁₀ = 140 nm, D₅₀ = 250 nm, D₉₀ = 450 nm; ZrO₂ powder used has D₁₀ = 2 nm, D₅₀ = 3 nm, D₉₀ = 5 nm; TiO₂-1 powder used has D₁₀ = 14 nm, D₅₀ = 18 nm, D₉₀ = 28 nm. TiO₂-2 powder used has D₁₀ = 29 nm, D₅₀ = 38 nm, D₉₀ = 59 nm.

1. A ceramic filtration element comprising:
a support structure; and
a filtration layer comprising at least first particles and second particles selected from a group consisting of oxide ceramic particles,
wherein the first and second particles differ in at least D₅₀ diameters, and
a ratio (Y) of a particle size of the first particles Q₁ (D₅₀) and a particle size of the second particles Q₂ (D₅₀) is in a range of 2 to 5,000.

2. The ceramic filtration element according to claim 1, wherein the first particles are selected from a group of metal carbides or metal nitrides, and the ratio Y is in a range of 5 to 4,000, below 5,000, or above 1; or
the first particles are selected from a group of metal oxides, and the ratio Y is in a range of 2 to 4,000, below 5,000, or above 1.

3. The ceramic filtration element according to claim 1, wherein the first particles are selected from a group consisting of SiC, Si₃N₄, WC, AlN, BN, B₄C, TiN, and mixtures thereof, and
the second particles are selected from a group consisting of Al₂O₃, BeO, CaO, HfO₂, FeO, Fe₂O₃, La₂O₃, MgO, MnO₂, SiO₂, SrO, ThO₂, TiO₂, Y₂O₃, ZrO₂, and mixtures thereof.

4. The ceramic filtration element according to claim 1, wherein the first particles are selected from a group consisting of Al₂O₃, BeO, CaO, HfO₂, FeO, Fe₂O₃, La₂O₃, MgO, MnO₂, SiO₂, SrO, ThO₂, TiO₂, Y₂O₃, ZrO₂, and mixtures thereof, and
the second particles are selected from a group consisting of Al₂O₃, BeO, CaO, HfO₂, FeO, Fe₂O₃, La₂O₃, MgO, MnO₂, SiO₂, SrO, ThO₂, TiO₂, Y₂O₃, ZrO₂, and mixtures thereof.

5. The ceramic filtration element according to claim 1, wherein the first particle is SiC and the second particle is ZrO₂,
the first particle is SiC and the second particle is TiO₂,
the first particle is SiC and the second particle is Al₂O₃,
the first particle is AlN and the second particle is Al₂O₃,
the first particle is AlN and the second particle is ZrO₂,
the first particle is AlN and the second particle is TiO₂,
the first particle is Si₃N₄ and the second particle is Al₂O₃,
the first particle is Si₃N₄ and the second particle is ZrO₂,
the first particle is Si₃N₄ and the second particle is TiO₂,
the first particle is BN and the second particle is Al₂O₃,
the first particle is BN and the second particle is TiO₂, or
the first particle is BN and the second particle is ZrO₂.

6. The ceramic filtration element according to claim 1, wherein the first particle is ZrO₂ and the second particle is ZrO₂,
the first particle is ZrO₂ and the second particle is TiO₂,
the first particle is ZrO₂ and the second particle is Al₂O₃,
the first particle is TiO₂ and the second particle is ZrO₂,
the first particle is TiO₂ and the second particle is TiO₂,
the first particle is TiO₂ and the second particle is Al₂O₃,
the first particle is Al₂O₃ and the second particle is Al₂O₃,
the first particle is Al₂O₃ and the second particle is ZrO₂, or
the first particle is Al₂O₃ and the second particle is TiO₂.

7. The ceramic filtration element according to claim 1, wherein the second particle is present in an amount of from 1 wt.-% to 50 wt.-% based on a total weight of the first and second particles.

8. The ceramic filtration element according to claim 1, wherein the second particles have a diameter D₅₀ of from 1 nm to 150 nm, and
D₉₀ is in a range of from 3 nm to 400 nm.

9. The ceramic filtration element according to claim 1, wherein the first particles have a diameter D₅₀ of from 10 nm to 15 μm, and
D₉₀ is in a range of from 20 nm to 6 μm.

10. A process of manufacturing a ceramic filtration element, the process comprising:
providing a support structure having a support surface, and a coating suspension comprising first and second particles;
contacting the support surface with the coating suspension for a duration of time;
removing excess of the coating suspension without removing a residual film of the coating suspension;
drying the residual film; and
sintering the support structure with the residual film.

11. The process according to claim 10, further comprising repeating the contacting, the removing, the drying and the sintering a number of times.

12. The process according claim 10, wherein the first particles are selected from a group consisting of metal carbides or metal nitrides, and
the sintering is performed at a temperature in a range of from 300° C. to 900° C.

13. The process according claim 10, wherein the first particles are selected from a group consisting of metal oxides, and
the sintering is performed at a temperature in a range of from 300° C. to 1,500° C.

14. The process according to claim 10, wherein the sintering is performed in an atmosphere comprising oxygen.

15. The process according to claim 10, wherein the coating suspension comprises at least 1 wt.-% of the first particle, based on a total weight of a mixture.

16. The process according to claim 10, wherein the coating suspension comprises at least 0.1 wt.-% of the second particle based on a total weight of a mixture.
